(19) United States
(12) Patent Application Publication
(10) Pub. No.: US 2016/0189202 A1
(43) Pub. Date: Jun. 30, 2016

(54) SYSTEMS AND METHODS FOR MEASURING COMPLEX ONLINE STRATEGY EFFECTIVENESS

(71) Applicant: Yahoo! Inc., Sunnyvale, CA (US)

(72) Inventors: Pengyuan WANG, Sunnyvale, CA (US); Dawei Yin, San Jose, CA (US); Yi Chang, Milpitas, CA (US); Jian Yang, Palo Alto, CA (US); Wei Sun, West Lafayette, IN (US)

(73) Assignee: Yahoo! Inc., Sunnyvale, CA (US)

(21) Appl. No.: 14/587,328

(22) Filed: Dec. 31, 2014

(51) Int. Cl. G06Q 30/02; G06F 17/30; G06Q 10/06

(52) U.S. Cl. CPC G06Q 30/0243; G06Q 10/067; G06F 17/30327

(57) ABSTRACT

Systems and methods for are provided for measuring treatment effect of advertisement campaigns. The system includes a processor and a non-transitory storage medium accessible to the processor. The system includes a memory storing a database including historical advertisement data. A computer server is in communication with the memory and the database, the computer server programmed to obtain a tree-based model using the historical advertisement data, where the tree-based model include a plurality of leaf nodes. Within at least one leaf node of the tree-based model, the computer server obtains a number of subjects and estimates a treatment effect for a treatment. The computer server calculates a final treatment effect for the tree-based model using the number of subjects and the treatment effect. The computer server then determines a parameter for future advertising strategy using the final treatment effect.

### BACKGROUND

The Internet is a ubiquitous medium of communication in most parts of the world. The emergence of the Internet has opened a new forum for the creation and placement of advertisements (ads) promoting products, services, and brands. As the Internet industry has evolved into an age with diverse user treatment strategies (for example, different advertising formats and delivery channels shown to the users), the market increasingly demands a reliable measurement and a sound comparison of the impact of the different user treatments on user actions (for example, online conversion actions). A metric is needed to show changes in user actions independent of variables that characterize online users. The metric needs to be able to isolate the effect of the user treatments from the effect of other variables.

In the current online advertising ecosystem, users are exposed to ads with diverse formats and channels, and users' behaviors are caused by complex ad treatments combining various factors. The online ad delivery channels may include search, display, e-mail, mobile and so on. Besides the multi-channel exposure, ad creative characteristics and context may also affect ad effectiveness. Hence the ad treatments are becoming a combination of various factors mentioned above. The complexity of ad treatments calls for accurate and causal measurement of ad effectiveness, i.e., how the ad treatment causes the changes in outcomes.

Generally, ad effectiveness is measured by investigating the proportion of people who converted or performed other success actions after they saw the ads. These metrics commonly overestimate campaign effectiveness since they do not account for users who would have performed actions even if the campaign did not happen. In other words, confounding effects of the user features, e.g., gender, age, occupation, etc., may become biases in the effectiveness measurement. In order to establish a causal relationship between ad treatments and conversions, such biases from user features need to be eliminated.

Further, conventional metrics do not recognize that the measure of ad effectiveness has multiple dimensions and thus, fails to answer the following questions that are important to advertisers: (1) Which users convert because they see the ad and which users would have converted even if they do not see the ad? (2) What is the cumulative effect of multiple advertising strategies on performance? (3) How does a campaign affect the size of the potential customer pool?

Therefore, there is a need to provide an improved solution for measuring effectiveness of user treatment to solve the above-mentioned problems.

### SUMMARY

Different from conventional solutions, the disclosed system solves the above problem by measuring the treatment effect of online strategies, where the treatment may include a combination of various factors.

In a first aspect, the embodiments disclose a computer system that includes a processor and a non-transitory storage medium accessible to the processor. The system also includes a memory storing a database comprising historical advertisement data. A computer server is in communication with the memory and the database, the computer server programmed to obtain a tree-based model using the historical advertisement data, where the tree-based model include a plurality of leaf nodes. Within at least one leaf node of the tree-based model, the computer server obtains a number of subjects and estimates a treatment effect for a treatment. The computer server calculates a final treatment effect for the tree-based model using the number of subjects and the treatment effect. The computer server then determines a parameter for future advertising strategy using the final treatment effect.

In a second aspect, the embodiments disclose a computer implemented method by a system that includes one or more devices having a processor. In the computer implemented method, the system obtains a tree-based model using historical advertisement data, the tree-based model comprising a plurality of leaf nodes. Within at least one leaf node of the tree-based model, the system obtains a number of subjects and estimates a treatment effect for a treatment. The system calculates a final treatment effect for the tree-based model using the number of subjects and the treatment effect. The system determines a parameter for future advertising strategy using the final treatment effect.

In a third aspect, the embodiments disclose a non-transitory storage medium configured to store a set of modules. The non-transitory storage medium includes a module for obtaining a tree-based model using advertisement data, where the tree-based model includes a plurality of leaf nodes. The non-transitory storage medium further includes a module for obtaining a number of subjects and estimating a treatment effect for a treatment within at least one leaf node of the tree-based model. The non-transitory storage medium further includes a module for calculating a final treatment effect for the tree-based model using the number of subjects and the treatment effect. The non-transitory storage medium further includes a module for determining a parameter for future advertising strategy using the final treatment effect. The advertisement data include: user treatment data, user feature data, and observational data collected from a plurality of platforms including: Internet platforms and TV networks.

### BRIEF DESCRIPTION OF THE DRAWINGS

FIG. 1 is a block diagram of an example environment in which a computer system according to embodiments of the disclosure may operate;

FIG. 2 illustrates an example computing device in the computer system;

FIG. 3 illustrates an example embodiment of a server computer for building a keyword index for an audience segment;

FIG. 4 is an example block diagram illustrating embodiments of the non-transitory storage of the server computer;

FIG. 5 is an example flow diagram illustrating embodiments of the disclosure;

FIG. 6 is an example flow diagram illustrating embodiments of the disclosure;

FIG. 7 is an example tree-based model according to embodiments of the disclosure;

FIG. 8 is an example illustration according to embodiments of the disclosure;

FIG. 9 is an example illustration according to embodiments of the disclosure; and

FIG. 10 is an example illustration according to embodiments of the disclosure.

### DETAILED DESCRIPTION OF THE DRAWINGS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

While the publisher and social networks collect more and more user data through different types e-commerce applications, news applications, games, social networks applications, and other mobile applications on different mobile devices, a user may by tagged with different features accordingly. Using these different tagged features, online advertising providers may create more and more audience segments to meet the different targeting goals of different advertisers. Thus, it is desirable for advertisers to directly select the audience segments with the best performances using keywords. Further, it would be desirable to the online advertising providers to provide more efficient services to the advertisers so that the advertisers can select the audience segments without reading through the different features or descriptions of the audience segments. The present disclosure provides a computer system that uses a keyword vector to represent an audience segment and provides intuitive user interfaces to allow advertisers to use keywords to search for any audience segments.

Ideally, the gold standard of accurate ad effectiveness measurement is the experiment-based approach, such as A/B test, where different ad treatments are randomly assigned to users. However, the cost of fully randomized experiments is usually very high and in some rich ad treatment circumstances, such fully randomized experiments are even infeasible. The major obstacles to achieve fully randomized experiments include the following. 1) Implementing a platform for supporting ideal experiments, i.e., perfect randomization, often involves the change of system architecture, which might cause much prohibited engineering effort. 2) When the treatments are a combination of various factors, one might not be able to fully explore all possible combinations of treatments due to the lack of population. 3) The treatment may not be feasible for large-scale experiments, such as the number of ad impressions. In online advertising, it is easy to randomly assign users to see or not see the ad impression, but it is difficult to fully control the number of impressions, except utilizing field experiments, which is costly and usually can be conducted only on a relatively small scale. 4) Even if the experiments are perfectly randomized and the ad treatments can fit into an experiment framework, one still should be cautious due to the fact that the randomized experiments may hurt both user experience and ad revenue. Hence it is critical and necessary to provide statistical approaches to estimate the ad effectiveness directly from observational data rather than experimental data.

Previous studies based on observational data try to establish direct relationship between the ad treatment and a success signal, etc. However, in observational data, typically the user characteristics may affect both the exposed ad treatment and the success tendency. Such confounding effects of user characteristics are called selection biases, and ignoring the confounding effects may lead to biased estimation of the treatment effect. For example, assuming in an auto campaign all of the exposed users are males and all of the non-exposed users are females, if the males generally have a larger success rate than females, the effectiveness of the campaign may be overestimated because of the confounding effects of the user characteristics - - - in this case, gender. It might just be that males are more likely to be exposed and perform success actions. Therefore, the relationship between the ad treatments and the success is not causal without eliminating the selection bias.

A straightforward approach attempting to eliminate the selection biases is to adjust the outcome with the user characteristics using supervised learning. However a technical problem exists in that the user characteristics may have complex relationships, e.g., nonlinearity, with the treatments and the outcome, and it is not trivial to estimate the causal effect of the treatment by adjusting the outcome with the user characteristics directly.

To address the aforementioned technical problems, a computer system including the causal inference is developed to estimate unbiased causality effect of the ad treatment from observational data. The observational data may include performance measurements of corresponding treatments on chosen outcome metric. For example, the performance measurements may include pre-defined success rates, conversion rates, click through rates (CTR), and etc.

In the online advertisement technology, measuring ad treatment effectiveness faces at least three major challenges. First, the general ad treatment can be much more complex than binary ad treatment because it may be a discrete or continuous, single- or multi-dimensional treatment. To design an analytics framework encompassing so many ad factors is not trivial. Second, the online observational dataset typically has huge volume of records and user characteristics, which demands the methodology to be highly efficient. Traditional statistical causal inference approaches usually cannot reach efficiency required by the advertising industry. Third, when the treatments become more complex, existing methods are usually sensitive to parameter settings. To overcome the sensitivity, a robust causal inference approach is provided here.

This disclosure provides a computationally efficient tree-based causal inference framework to tackle the general ad effectiveness measurement problem. The tree-based model is well suited for the online advertising datasets which consist of complex treatments, a huge volume of users, and high-dimensional features. The causal inference is fully general, where the treatment may be single dimensional or multi-dimensional, and it may be binary, categorical, continuous, or a mixture of them. Compared to previous causal inference work, the proposed approach is more robust and highly flexible with minimal manual tuning. The tree-based model automatically determines the important tuning parameters that were chosen arbitrarily in the traditional causal inference methods in a nonparametric way. In addition, the tree-based model is easy to implement and computationally efficient for large scale online data.

The tree-based framework is further wrapped in a bagging procedure to enhance the stability and improve the performance of the final estimator. More importantly, the bagged strategy provides with statistical inference of the obtained point estimators, where the confidence intervals of the estimated treatment effects could be established for hypothesis testing purpose.

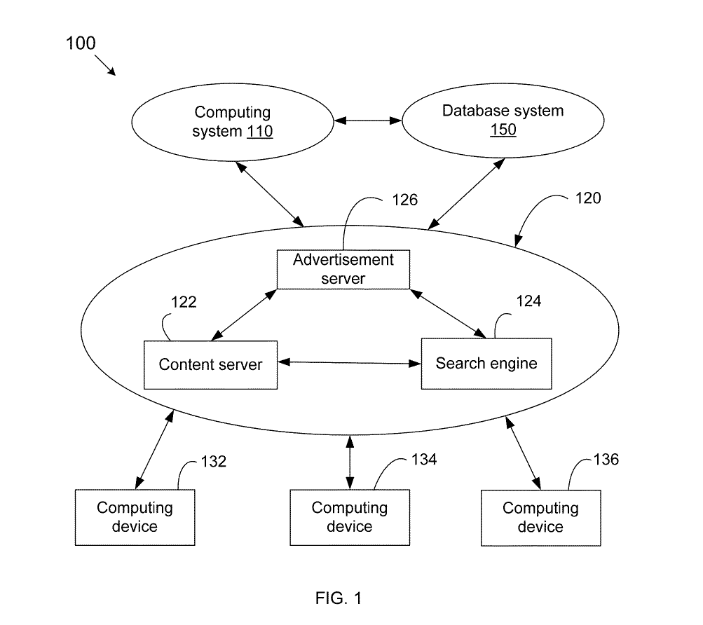

Referring now to the drawing figures, FIG. 1 is a block diagram of an environment 100 in which a computer system according to embodiments of the disclosure may operate. However, it should be appreciated that the systems and methods described below are not limited to use with the particular exemplary environment 100 shown in FIG. 1 but may be extended to a wide variety of implementations.

The environment 100 may include a computing system 110 and a connected server system 120 including a content server 122, a search engine 124, and an advertisement server 126. The computing system 110 may include a cloud computing environment or other computer servers. The server system 120 may include additional servers for additional computing or service purposes. For example, the server system 120 may include servers for social networks, online shopping sites, and any other online services.

The computing system 110 may include a backend computer server. The backend computer server is in communication with the database system 150. The backend computer server is programmed to: obtain a performance-lift vector for an audience segment, obtain a keyword vector for the audience segment at least partially based on the performance-lift vector, and save the keyword vector in the database 150. The backend computer server is further programmed to: obtain a campaign vector that comprises a sub-vector of keywords and a sub-vector of weighs corresponding to the sub-vector of keywords, and the sub-vector of keywords comprises keywords at least partially related to creative landing uniform resource locator (URL), advertiser name, and product name. The backend computer server is programmed to obtain and update the performance-lift vector, the campaign vector, and the keyword vector periodically in an offline training process. The backend computer server is programmed to obtain the sub-vector of weighs corresponding to the sub-vector of keywords using a process based on a term frequency-inverse document frequency (TF-IDF) of the keywords in the sub-vector of keywords.

The content server 122 may be a computer, a server, or any other computing device known in the art, or the content server 122 may be a computer program, instructions, and/or software code stored on a computer-readable storage medium that runs on a processor of a single server, a plurality of servers, or any other type of computing device known in the art. The content server 122 delivers content, such as a web page, using the Hypertext Transfer Protocol and/or other protocols. The content server 122 may also be a virtual machine running a program that delivers content.

The search engine 124 may be a computer system, one or more servers, or any other computing device known in the art, or the search engine 124 may be a computer program, instructions, and/or software code stored on a computer-readable storage medium that runs on a processor of a single server, a plurality of servers, or any other type of computing device known in the art. The search engine 124 is designed to help users find information located on the Internet or an intranet.

The advertisement server 126 may be a computer system, one or more computer servers, or any other computing device known in the art, or the advertisement server 126 may be a computer program, instructions and/or software code stored on a computer-readable storage medium that runs on a processor of a single server, a plurality of servers, or any other type of computing device known in the art. The advertisement server 126 is designed to provide digital ads to a web user based on display conditions requested by the advertiser. The advertisement server 126 may include computer servers for providing ads to different platforms and websites.

The computing system 110 and the connected server system 120 have access to a database system 150. The database system 150 may include memory such as disk memory or semiconductor memory to implement one or more databases. At least one of the databases in the database system may be a user database that stores information related to a plurality of users. The user database may be organized on a user-by-user basis such that each user has a unique record file. The record file may include all information related to a specific user from all data sources. For example, the record file may include personal information of the user, search histories of the user from the search engine 124, web browsing histories of the user from the content server 122, or any other information the user agreed to share with a service provider that is affiliated with the computer server system 120.

The environment 100 may further include a plurality of computing devices 132, 134, and 136. The computing devices may be a computer, a smart phone, a personal digital aid, a digital reader, a Global Positioning System (GPS) receiver, or any other device that may be used to access the Internet.

The disclosed system and method for building keyword searchable audience segments may be implemented by the computing system 110. Alternatively or additionally, the system and method for building keyword searchable audience segments may be implemented by one or more of the servers in the server system 120. The disclosed system may instruct the computing devices 132, 134, and 136 to display all or part of the user interfaces to request input from the advertisers. The disclosed system may also instruct the computing devices 132, 134, and 136 to display all or part of the brand performance to the advertisers.

Generally, an advertiser or any other user may use a computing device such as computing devices 132, 134, and 136 to access information on the server system 120 and the data in the database 150. The advertiser may want to identify a parameter for an advertisement campaign. Based on the observational data, the advertiser may want to measure synthetic impact of ad exposure from different platforms. One of the technical problems solved by the disclosure is to increase the efficiency of advertisement campaign setup so that an advertiser may reach maximum benefit with minimum cost.

Further, the system solves technical problems presented by managing large amounts of user data represented by different user features collected by all types of mobile applications. Through processing collected data, the systems provide an unbiased estimation of the ad effectiveness by controlling the confounding effect of user characteristics.

The system further providers a framework that is computationally efficient by employing a tree structure to model the relationship between user characteristics and the corresponding ad treatment.

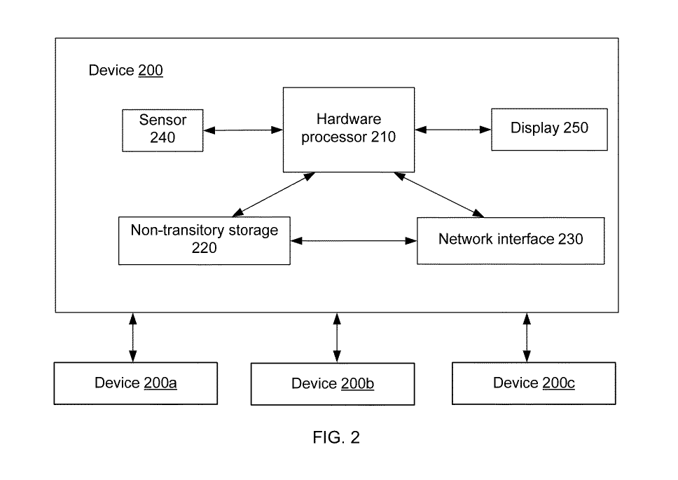

FIG. 2 illustrates an example computing device 200 for interacting with the advertiser. The computing device 200 may communicate with a computer server of the system. The computing device 200 may be a computer, a smartphone, a server, a terminal device, or any other computing device including a hardware processor 210, a non-transitory storage medium 220, and a network interface 230. The hardware processor 210 accesses the programs and data stored in the non-transitory storage medium 220. The device 200 may further include at least one sensor 240, circuits, and other electronic components. The device may communicate with other devices 200a, 200b, and 200c via the network interface 230.

The computing device 200 may display user interfaces on a display unit 250. For example, the computing device 200 may display a user interface on the display unit 250 asking the advertiser to input one or more keywords. The user interface may provide checkboxes, dropdown selections or other types of graphical user interfaces for the advertiser to select geographical information, demographical information, mobile application information, technology information, publisher information, or other information related to features of an audience segment.

The computing device 200 may further display the predicted performance using one or more audience segments. The computing device 200 may also display one or more drawings or figures that have different formats such as bar charts, pie charts, trend lines, area charts, etc. The drawings and figures may represent the tree model or indicate the unbiased estimation result.

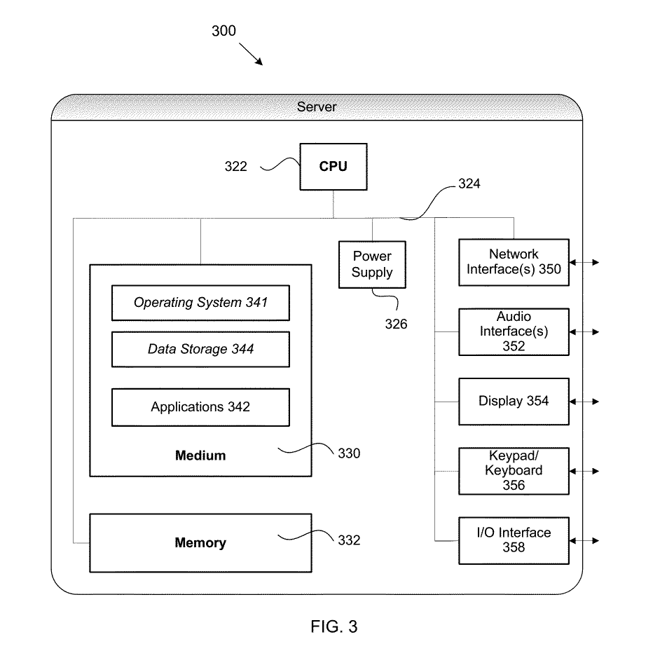

FIG. 3 is a schematic diagram illustrating an example embodiment of a server. A server 300 may include different hardware configurations or capabilities. For example, a server 300 may include one or more central processing units 322, memory 332 that is accessible to the one or more central processing units 322, one or more medium 630 (such as one or more mass storage devices) that store application programs 342 or data 344, one or more power supplies 326, one or more wired or wireless network interfaces 350, one or more input/output interfaces 358. The memory 332 may include non-transitory storage memory and transitory storage memory.

A server 300 may also include one or more operating systems 341, such as Windows Server, Mac OS X, Unix, Linux, FreeBSD, or the like. Thus, a server 300 may include, as examples, dedicated rack-mounted servers, desktop computers, laptop computers, set top boxes, integrated devices combining various features, such as two or more features of the foregoing devices, or the like.

The server 300 in FIG. 3 may serve as any computer server shown in FIG. 1. The server 300 may also serve as a computer server that implements the computer system for building keyword searchable audience segments. In either case, the server 300 is in communication with a database that stores historical advertisement data. The historical advertisement data may include user treatment data, user feature data, and observational data. The user treatment data may include at least one of: advertisement frequencies, advertisement features, advertisement time slots, and advertisement delivery channels. Other user treatment data may be stored and processed as well. The user feature data user characteristics include: user demographic data, user interest data, online user activity data, and TV view user activity data. Other user feature data may be stored and processed as well. The observational data includes performance measurements of corresponding treatments such as purchase indicators. Other observational data may be stored and processed as well.

For example, the set of potential treatment values may be defined to be T, and hence each value tε T indicates a specific treatment, which may be uni-dimensional or multi-dimensional. For a specific user, the treatment is a random variable T, which is supported on T. Similarly, the potential outcome associated with a specific treatment t is Y(t), which is the random variable mapping the given treatment t to a potential outcome supported on the set of potential outcomes Y. Since the treatment may be uni-dimensional or multi-dimensional, the boldface T and t are used to indicate a multivariate treatment variable and T and t are used to indicate a univariate treatment variable. The disclosed methods designed for multivariate treatment T may also be applied to univariate treatment T.

In a binary treatment case, T={0,1} with 1 indicating, for example, ad exposure and 0 indicating no ad exposure. In general, T may be multivariate and of a mixture of categorical and continuous variables. The server 300 is programmed to evaluate the effect of treatment t on the outcome Y, removing the confounding effect of X.

The users may be indexed by i=1,2, . . . , N. The database includes a vector of pretreatment covariates (i.e., user characteristics) Xi of length p, a treatment Ti and a univariate outcome Yi (e.g., purchase indicator) corresponding to the treatment received.

The server 300 may be programmed to obtain a tree-based model using the historical advertisement data, where the tree-based model includes a plurality of leaf nodes. The tree-based model introduces a model free method which avoids the choice of the number of sub-classes and the strategy of sub-classification.

Generally, the unbiased estimation of treatment effect may be obtained by the following equation.

p(Y(t))=∫_{e(X)}p(Y(t)|T=t,e(X))p(e(X))de(X)

where the propensity function e(X) is defined as the conditional density of the treatment given the observed covariates, i.e., e(X)=p(T|X). The integral in the above equation may be approximated by classifying the subjects into several sub-classes with similar value of e(X), and then averaging the estimators from each sub-class. The server 300 utilizes the tree structure to model e(X) nonparametrically and classify the users automatically. The number of sub-classes is also determined by the tree model, thus avoiding arbitrary selection of the number of sub-classes. The server 300 naturally partitions the treatment space into disjoint groups and hence is ideal to automate the classification and the rest of the causal inference calculation. In summary, compared to the previous methods, the tree-based model is a nonparametric approach, which requires fewer assumptions.

The server 300 is programmed to obtain a number of subjects and estimate a treatment effect for a treatment within at least one leaf node of the tree-based model. The estimation may vary with great flexibility. For example, when the treatment T is discrete, a straightforward nonparametric way to estimate the treatment effect in each node s is to compute the average of outcome Y corresponding to various treatments T, and then subtract the averaged outcome of a baseline treatment. For instance, for a bivariate and binary treatment T=(T₁,T₂)^{T} with (T₁,T₂)ε {0,1}², within at least one node s, the server estimates the effect of treatment t as Rₛ(t)=Y̅(t)−Y̅(t₀) with t₀=(0,0)^{T} as the baseline treatment, where Y̅(□) refers to the averaged outcome. When the treatment T is continuous, the server 300 may fit any proper nonparametric or parametric model for Y|(T,X) within a leaf node(sub-class) s. The choice of the specific model to fit within leaf node s is not limited to any specific model. In other words, the server may implement the method with any proper model to fit Y|(T,X) within a leaf node s.

The server 300 is programmed to calculate a final treatment effect for the tree-based model using the number of subjects and the treatment effect. For example, the server may use the classification and regression trees (CART) guideline to construct a single tree. Other similar methods may be used to construct the tree. The tuning parameters may be selected based on a 10-fold cross validation. After the tree construction, within each leaf node s, the server 300 estimates Rₛ(t) and then estimates the final averaged treatment effect (ATE) as

$$ATE = {\sum }_{s} \frac{{N}_{s}}{N} \{ {R}_{s} ( t ) - {R}_{s} ( {t}_{0} ) \} ,$$

where t₀ is the baseline treatment.

The server 300 is programmed to determine a parameter for future advertising strategy using the final treatment effect. For example, the parameter may include ad frequency, ad content format, ad layout, and other parameters for ad display or delivery. Specifically, given a dataset with ad frequency, user actions and characteristics, this server 300 is programmed to determine the optimal ad frequency for this campaign. The server 300 may also provide optimal ad frequencies in two or more campaigns running on different platforms in the same time.

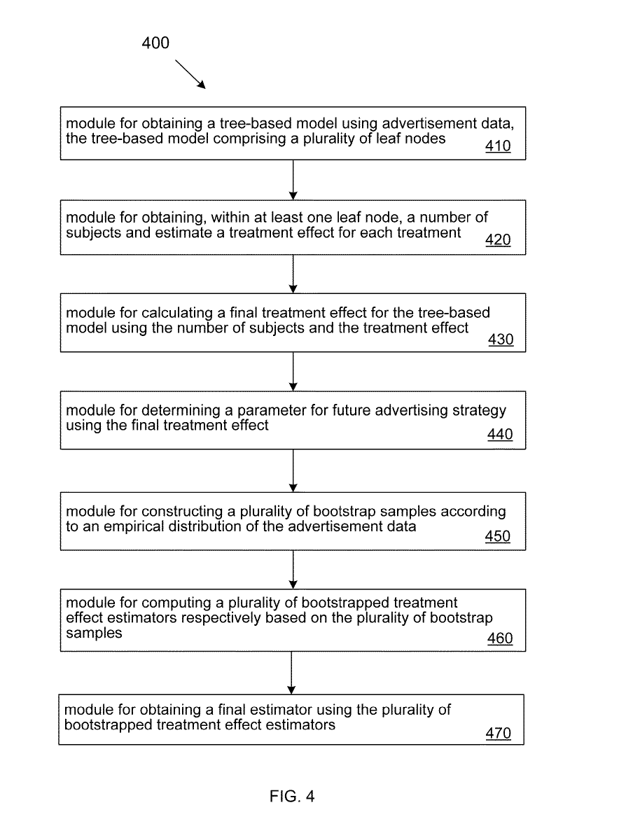

FIG. 4 illustrates embodiments of a non-transitory storage medium 400 in the server 300 illustrated in FIG. 3. The non-transitory storage medium 400 includes one or more modules. The one or more modules may be implemented as program code and data stored on the non-transitory storage medium, for example. The non-transitory storage medium 400 may include alternative, additional or fewer modules in other embodiments. The non-transitory storage medium 400 includes a module for recording data in a database.

The non-transitory storage medium 400 includes a module 410 for obtaining a tree-based model using advertisement data, where the tree-based model may include a plurality of leaf nodes. When the treatment T is continuous, the leaf node may include any proper nonparametric or parametric model for Y|(T,X) within as a sub-class s. Within each leaf node, there may be various ways to estimate the treatment impact via controlling the confounding effect of the covariates on treatments. The choice of the specific model to fit within leaf node s is not limited to any specific model.

The non-transitory storage medium 400 includes a module 420 for obtaining, within at least one leaf node of the tree-based model, a number of subjects and estimating a treatment effect for a treatment. For example, within a leaf node of the tree, the computer system may calculate the success rates of the non-exposed group and the exposed group for a given treatment. The computer system may estimate the treatment effect as the difference of the two success rates. Then the population level treatment effect is estimated as the weighted average of the results from each node with weight proportional to the node sizes.

The non-transitory storage medium 400 includes a module 430 for calculating a final treatment effect for the tree-based model using the number of subjects and the treatment effect. For example, the computer system may obtain the final treatment effect by estimating the treatment effect within each leaf node, and taking the weighted average across all the leaf nodes as the final estimation.

The non-transitory storage medium 400 includes a module 440 for determining a parameter for future advertising strategy using the final treatment effect. The advertisement data may include: user treatment data, user feature data, and observational data collected from a plurality of platforms including: Internet platforms and TV networks. The computer system may plot drawings to show the correlation between ad frequencies and success rates. The computer system may select the parameter that results in the best performance. Using the tree-based model, the computer system can directly identify a treatment effect cap, which is usually over-estimated by naive estimation.

The non-transitory storage medium 400 may further include a module 450 for constructing a plurality of bootstrap samples according to an empirical distribution of the historical data. The bootstrap aggregating (bagging) may be applied to enhance the performance of non-robust methods by reducing the variance of a predictor. Here, the computer system may adopt the bagging strategy to improve the robustness of the tree-based model. For instance, in the bagged tree-based causal inference, the computer system may repeatedly generate bootstrap samples (i.e., a set of random samples drawn with replacement from the dataset), estimate the treatment effect based on the samples, and calculate the final results by averaging the results from the bootstrap sample sets at the end.

The non-transitory storage medium 400 may further include a module 460 for computing a plurality of bootstrapped treatment effect estimators respectively based on the plurality of bootstrap samples. The computer system may establish the confidence interval of the estimated treatment effect. For example, the computer system may calculate the bootstrapped mean and standard deviation of the final treatment effect according to the bootstrapped treatment effect estimators.

The non-transitory storage medium 400 may further include a module 470 for obtaining a final estimator using the plurality of bootstrapped treatment effect estimators. The final estimator may be calculated using the bootstrapped mean according to the equation

$${E}_{B} = \frac{1}{B} {\sum }_{b = 1}^{B} {E}^{* ( b )} ,$$

where E*^{(b)} is the final treatment effect for a bootstrap sample set b and B is the total number of bootstrap sample sets.

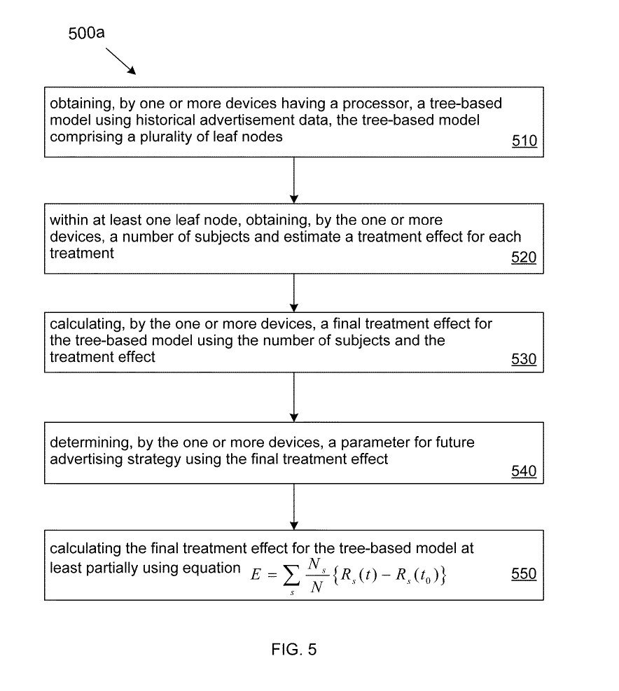

FIG. 5 is an example flow diagram 500a illustrating embodiments of the disclosure. The flow diagram 500a may be implemented at least partially by a computer system that includes a computer server 300 having a processor or computer and illustrated in FIG. 3. The computer implemented method according to the example flow diagram 500a includes the following acts. Other acts may be added or substituted.

In act 510, the computer system obtains a tree-based model using historical advertisement data, where the tree-based model may include a plurality of leaf nodes. For example, the computer system may obtain a binary tree-based model using historical advertisement data in one or more advertising campaigns. The historical advertisement data may include user treatment data, user feature data, and observational data collected from one or more platforms.

In act 520, the computer system obtains a number of subjects and estimates a treatment effect for a treatment. The computer system may perform the act 520 within at least one leaf node of the tree-based model. For example, the subjects in each leaf node may have a homogeneous density of T, the effect of treatment t may be equal to the expected outcome corresponding to treatment t averaged over the leaf node in the proposed tree-based method. Thus, the computer system uses the tree model to automatically seek the partition such that the predictor space is the most separable and hence the distribution of T gets more and more homogeneous within each leaf node as the tree grows.

In act 530, the computer system calculates a final treatment effect for the tree-based model using the number of subjects and the treatment effect. For example, the computer system may calculate a final treatment effect for the tree-based model using the number of subjects Nₛ and the treatment effect Rₛ(t) for each treatment t.

In act 540, the computer system determines a parameter for future advertising strategy using the final treatment effect. Using the final treatment effect, the computer system may draw a plot to show a relationship between the treatment and the performance measurements. For example, the computer system may draw a figure to show a relationship between the frequency of ad exposure and a final success rate. The success may be defined by advertisers based on their specific product or service.

In act 550, the computer system calculates the final treatment effect for the tree-based model at least partially using equation:

$$E = {\sum }_{s} \frac{{N}_{s}}{N} \{ {R}_{s} ( t ) - {R}_{s} ( {t}_{0} ) \} .$$

Here, E is the final treatment effect, s indicates a leaf node of the tree, t indicates a treatment, Rₛ(t) indicates a treatment effect for the treatment t in the leaf node s, and Rₛ(t₀) indicates a baseline treatment effect in the leaf node s.

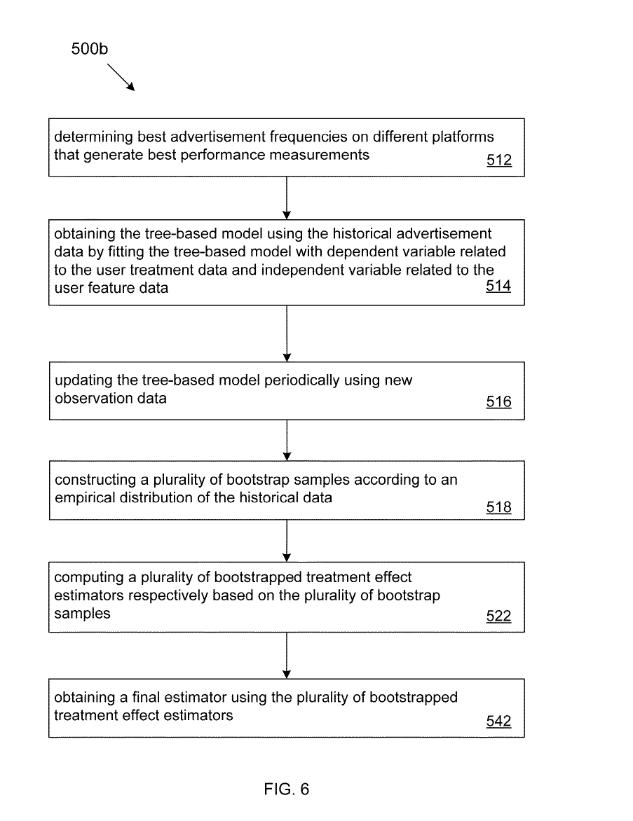

FIG. 6 is an example flow diagram 500b illustrating embodiments of the disclosure. The acts in the example block diagram 500b may be combined with the acts in the block diagram 500a shown in FIG. 5. Similarly, the acts in flow diagram 500b may be implemented at least partially by a computer system that includes a server computer 300 disclosed in FIG. 3. The computer implemented method according to the example flow diagram 500b includes the following acts. Other acts may be added or substituted.

In act 512, the computer system determines the best advertisement frequencies on different platforms that generate best performance measurements. The definition of the best performance measurements may be the maximum success rate of a campaign according to the observational data. This act may be performed as a part of act 540 in FIG. 5.

In act 514, the computer system obtains the tree-based model using the historical advertisement data by fitting the tree-based model with a dependent variable related to the user treatment data and an independent variable related to the user feature data. For example, when two platforms are involved, the computer system may fit a single tree model may by treating the two-dimensional treatment T as the dependent variable and the covariates X as the independent variables.

In act 516, the computer system updates the tree-based model periodically using new observational data. For example, the computer system may update daily or weekly when there more new observational data.

In act 518, the computer constructs a plurality of bootstrap samples according to an empirical distribution of the historical data. The bootstrap samples are generated using bootstrap aggregating, also called bagging. Bootstrap aggregating is a machine learning ensemble meta-algorithm designed to improve the stability and accuracy of machine learning algorithms used in statistical classification and regression. Bootstrap aggregating may also reduce variance and helps to avoid over-fitting. Bootstrap aggregating may be deemed as a special case of the model averaging approach.

In act 522, the computer system computes a plurality of bootstrapped treatment effect estimators respectively based on the plurality of bootstrap samples. Given a standard training set D of size n, bootstrap aggregating may generates m new training sets Dᵢ, each of size n′, by sampling from D uniformly and with replacement. By sampling with replacement, some observations may be repeated in each Dᵢ. If n′=n, then for large n the set Dᵢ is expected to have the fraction (1−1/e) (≈63.2%) of the unique examples of D, the rest being duplicates. This kind of sample is known as a bootstrap sample.

In act 542, the computer system obtains a final estimator using the plurality of bootstrapped treatment effect estimators. The final estimator may be calculated using the bootstrapped mean according to the equation

$${E}_{B} = \frac{1}{B} {\sum }_{b = 1}^{B} {E}^{* ( b )} ,$$

where E*^{(b)} is the final treatment effect for a bootstrap sample set b and B is the total number of bootstrap sample sets.

The computer system may send information indicative of the parameter for future advertising strategy using the final treatment effect to a terminal device accessible by the advertiser. The computer server may instruct the terminal device to display the parameter in a format according to advertiser preferences.

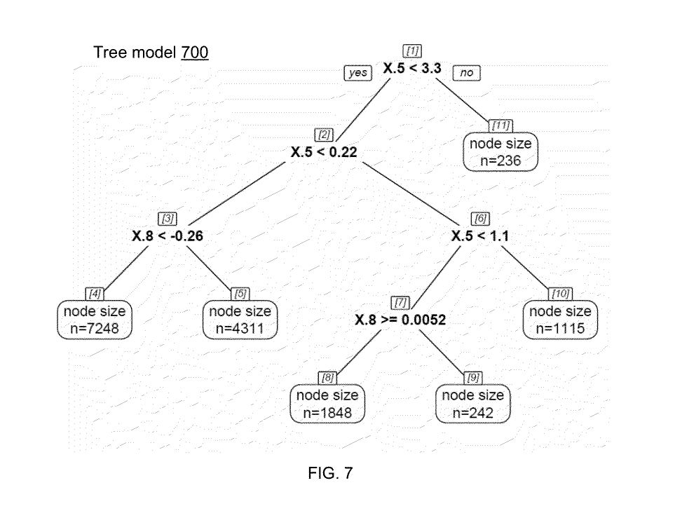

FIG. 7 is example tree-based model 700 according to embodiments of the disclosure. The disclosed system and method may be applied to real advertisement campaigns on one or more platforms. The success action may be defined as an online quote. For example, in a cross-platform study on a dataset from an auto insurance company, the treatment is a two-dimensional vector, including the numbers of ad exposures from TV and online platforms, separately. The computer system measures the impact of TV and online ads together, and hence addresses the synthetic impact of ad exposure from both platforms.

The dataset in the cross-platform study includes about 37 million users with 23 million non-exposed users and 14 million exposed users during a 30-day campaign. The original data are extremely imbalanced since the success rates are only 0.204% in the non-exposed group and 0.336% in the exposed group. To deal with this imbalance issue, the computer system employs the subsampling and back scaling in bootstrap aggregating, based on which the success rates of non-exposed group and exposed group in the sample increase to 16.9% and 16.7%, respectively.

TABLE 1

| | |
|---|---|
| Feature | Value |

Demographic Info and Interest

| | |
|---|---|
| Demographic \| Gender \| Male | 0 |
| Demographic \| Gender \| Female | 1 |
| Demographic \| Age | 27 |
| . . . | |
| Interest \| Celebrities | 0.01 |
| Interest \| Auto \| New | 0.23 |
| Interest \| Auto \| Used | 0.65 |
| . . . | |

Online Network Activities

| | |
|---|---|
| Site Visitation \| Finance | 67.4 |
| Site Visitation \| Movies | 1.3 |
| Site Visitation \| Sports | 0.0 |
| . . . | |
| Ad Impression \| Auto \| Company 1 | 7.24 |
| Ad Impression \| Insurance \| Company 2 | 9.43 |
| . . . | |

TV Activities

| | |
|---|---|
| TV Program Viewership \| Movies | 2.5 |
| TV Program Viewership \| Sports | 53.1 |
| . . . | |
| TV Ad Impression | 132.7 |
| . . . | |

The user features include the demographic information, personal interest, and online and TV activities. A sample of the user features and their corresponding values are shown below in Table 1 for illustration. Specifically, the demographic information consists of the user's gender, age, etc.; the personal interest measures how a user is interested in a specific category, e.g., auto; the online activity captures how often a user visits a particular website and the ad exposures to other companies; and the TV activity collects the TV watching information and the TV ad exposures. In this campaign, there are over two thousand features in total.

FIG. 7 shows model 700 as a single tree fitted by treating the two-dimensional treatment as the dependent variable and the covariates as the independent variables. In this single tree, nodes 4, 5, 8, 9, 10, and 11 are the leaf nodes. In each leaf node, the number indicates the node size.

Within each leaf node in the tree model 700 of FIG. 7, the computer server may calculate the success rates of non-exposed group and the exposed group for a given treatment, and hence the treatment effect is estimated as the difference of the two success rates. Then the population level treatment effect is estimated as the weighted average of the results from each node with weight proportional to the node sizes. The computer server may take the treatment with 1 television ad exposure and 2 online ad exposures as an example to illustrate the estimation process. Table 2 shows the results in estimating its treatment effect.

TABLE 2

| Node | | Non-exposed | Treatment | | |
|---|---|---|---|---|---|
| Index | Size | Success Rate | Success Rate | TE | ATE |
| [4] | 7248 | 1.14 | 3.84 | 2.70 | |
| [5] | 4311 | 0.85 | 1.45 | 0.60 | |
| [8] | 1848 | 0.56 | 0.66 | 0.10 | 1.86 |
| [9] | 242 | 0.42 | 0 | −0.42 | |
| [10] | 1115 | 0.92 | 6.70 | 5.78 | |
| [11] | 236 | 3.32 | 0 | −3.32 | |

Within each leaf node of the tree model 700, two widely used estimation proposals are used. Approach i) is the most naive estimator, which only estimates just the plain success rates with different treatments. Approach ii) is that, the computer system fits a logistic regression for the binary outcome with respect to the treatments and the covariates within each leaf node, and utilizes the coefficient of the treatments to represent the frequency impact.

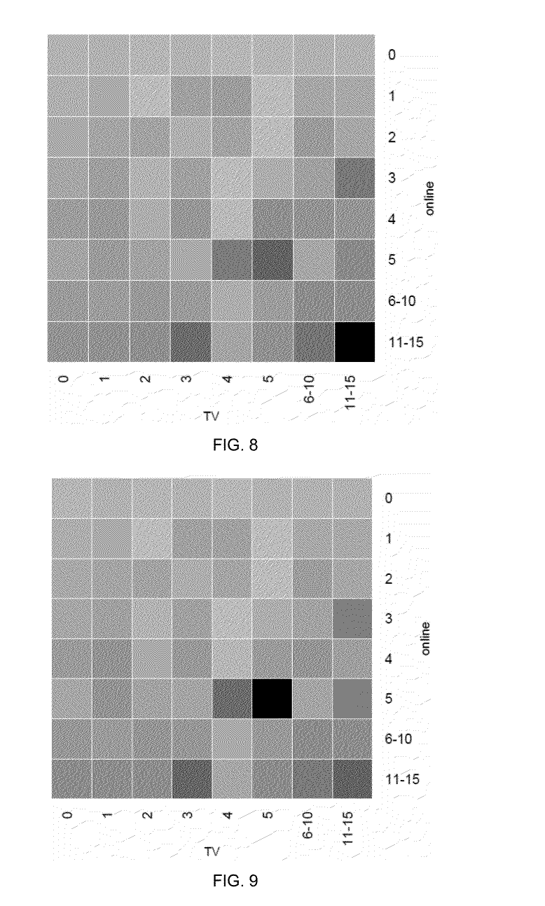

To compare the results from naive estimation without propensity adjustment and the causal inference estimation with the proposed framework, the computer system may first show the naive estimator for the ad frequency impact by simply computing the averaged outcomes corresponding to various treatments. The computer system may group both TV and online ad frequencies as 0, 1, 2, 3, 4, 5, 6-10, and 11-15 buckets. The computer system may employ this grouping scheme since the frequency decreases sharply when it is larger than 5 and most of the frequency is less than 15. As shown in FIG. 8, the naive estimator implies that the highest success rate is obtained when the users are shown 11-15 TV ads and 11-15 online ads. In addition, it shows that generally the ad effects get larger as the number of ad exposures increases for both TV and online platforms. Obviously, this plausible conclusion is biased and the superficial treatment effect is affected by the confounding effect of the user features.

By controlling the confounding effects of the covariates, the tree-based causal inference estimator is able to generate an unbiased estimator. The computer system may employ the bagging tree-based algorithm with B=100. In both FIGS. 8 and 9, the rows are the online ad frequency and the columns are the TV ad frequency. As illustrated in FIG. 9, the largest success rate is obtained when the users are shown 5 online ads and 5 TV ads. Furthermore, the computer system finds that the online ad effect is marginally larger than the TV ad by comparing the success rate of 0 TV ad exposure (first column in FIG. 9) with that of 0 online ad exposure (first row in FIG. 9). This suggests that users generally have a larger chance to conduct quotes on the insurance company website when they are shown online ads instead of the TV ads. Finally, both the online and TV ad effects will increase to a maximal value and then decrease as the users are shown more ads. Therefore, the computer system enables the ad providers to make appropriate adjustment based on the number and type of the ads the users have been exposed to.

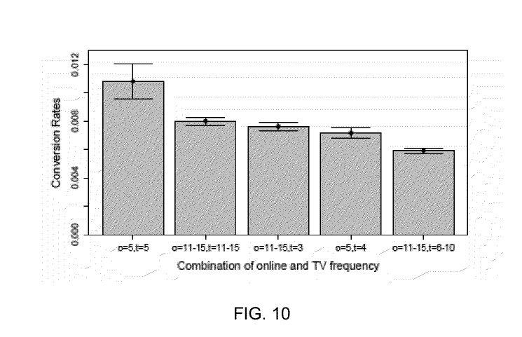

Furthermore, the computer system may employ the bootstrapping approach to estimate the standard deviation of the ATE estimator based on bootstrapping samples. FIG. 10 shows the top five highest success rates as well as their corresponding one standard deviation bars. Clearly, the combination of 5 online ads and 5 TV ads is shown to achieve a significantly larger success rate than other combinations.

As disclosed above, the tree-based model is flexible to use other fitting models. For example, the tree-based model may fit a sparse logistic regression with the success as the binary outcome, and the ad exposures from the two platforms and their interaction term as well as the user features as the independent variables. The tuning parameter λ in the sparse logistic regression model is selected via cross validation. The causality coefficients of the ad exposure from online, TV and interaction are 0.066, −0.001, and −0.0001 with the standard deviations 0.0393, 0.0183, and 0.0005. This ensures that online ad exposure has relatively positive effect on the success rate while the TV ad exposure has no significant effect. Hence the treatment effect is dominated by the online ad exposures, which is consistent with results from the nonparametric method.

The disclosed computer implemented method may be stored in a computer-readable storage medium. The computer-readable storage medium is accessible to at least one hardware processor. The processor is configured to implement the stored instructions to measure treatment effectiveness and assess advertising strategy on one or more platforms.

From the foregoing, it can be seen that the present embodiments provide a computer system that provide the causal impact of advertisements with different frequencies from one or more platforms. The analysis results show that the ad frequency usually has a treatment effect cap that may have been over-estimated by naive estimations. Hence it is important for the ad providers to make appropriate adjustment for the number of the ads delivered to the users. The solution is more general and not limited to is not limited to online advertising, but is also applicable to other tasks (e.g., social science, and user engagement studies) where causal impact of general treatments (e.g., UI design, content format, ad context, and etc.) needs to be measured with observational data.

The paper provides a novel causal inference framework for assessing the impact of general advertising treatments. The new framework enables analysis on uni-dimensional or multi-dimensional ad treatments, where each dimension (ad treatment factor) may be discrete or continuous. The computer system provides an unbiased estimation of the ad effectiveness by controlling the confounding effect of user characteristics. The framework is computationally efficient by employing a tree structure that specifies the relationship between user characteristics and the corresponding ad treatment. This tree-based framework is robust to model misspecification and highly flexible with minimal manual tuning. The computer system may be used to evaluate the impact of different ad frequencies and/or the synthetic ad effectiveness across TV and online platforms. The computer system using the tree-based framework shows that the ad frequency usually has a treatment effect cap and determines a parameter for future advertising considering the treatment effect cap. Advertisers may use the parameter to plan future advertising strategy that achieves maximum advertisement effectiveness with minimum cost.

It is therefore intended that the foregoing detailed description be regarded as illustrative rather than limiting, and that it be understood that it is the following claims, including all equivalents, that are intended to define the spirit and scope of this invention.

What is claimed is:

1. A system for measuring treatment effect, comprising:
a processor and a non-transitory storage medium accessible to the processor;
a memory storing a database comprising historical advertisement data;
a computer server in communication with the memory and the database, the computer server programmed to:
obtain a tree-based model using the historical advertisement data, the tree-based model comprising a plurality of leaf nodes;
within at least one leaf node of the tree-based model, obtain a number of subjects and estimate a treatment effect for a treatment;
calculate a final treatment effect for the tree-based model using the number of subjects and the treatment effect; and
determine a parameter for future advertising strategy using the final treatment effect.

2. The system of claim 1, wherein the historical advertisement data comprise: user treatment data, user feature data, and observational data.

3. The system of claim 2,
wherein the user treatment data comprise at least one of: advertisement frequencies, advertisement features, advertisement time slots, and advertisement delivery channels; and
wherein the observational data comprises performance measurements of corresponding treatments.

4. The system of claim 3, wherein the user treatment data comprise advertisement frequencies on different platforms and the computer server is programmed to determine best advertisement frequencies on different platforms that generate best performance measurements.

5. The system of claim 2, wherein the computer server is programmed to obtain the tree-based model using the historical advertisement data by fitting the tree-based model with a dependent variable related to the user treatment data and an independent variable related to the user feature data.

6. The system of claim 2, wherein the user feature data comprise: user demographic data, user interest data, online user activity data, and TV view user activity data.

7. The system of claim 1, wherein the computer server is programmed to construct a plurality of bootstrap samples according to an empirical distribution of the historical advertisement data, compute a plurality of bootstrapped treatment effect estimators respectively based on the plurality of bootstrap samples, and obtain a final estimator using the plurality of bootstrapped treatment effect estimators.

8. The system of claim 1, wherein the computer server is programmed to calculate the final treatment effect for the tree-based model at least partially using equation:
$$E = {\sum }_{s} \frac{{N}_{s}}{N} \{ {R}_{s} ( t ) - {R}_{s} ( {t}_{0} ) \} ,$$
wherein E is the final treatment effect, s indicates a leaf node of the tree, t indicates a treatment, Rₛ(t) indicates a treatment effect for the treatment t in the leaf node s, and Rₛ(t₀) indicates a baseline treatment effect in the leaf node s.

9. A method, comprising:
obtaining, by one or more devices having a processor, a tree-based model using historical advertisement data, the tree-based model comprising a plurality of leaf nodes;
within at least one leaf node of the tree-based model, obtaining, by the one or more devices, a number of subjects and estimate a treatment effect for a treatment; and
calculating, by the one or more devices, a final treatment effect for the tree-based model using the number of subjects and the treatment effect; and
determining, by the one or more devices, a parameter for future advertising strategy using the final treatment effect.

10. The method of claim 9, wherein the historical advertisement data comprise: user treatment data, user feature data, and observational data.

11. The method of claim 10,
wherein the user treatment data comprise at least one of: advertisement frequencies, advertisement features, advertisement time slots, advertisement delivery channels; and
wherein the observational data comprises performance measurements of corresponding treatments.

12. The method of claim 11,
wherein the user treatment data comprise advertisement frequencies on different platforms; and
wherein determining the parameter for future advertising strategy using the final treatment effect comprises determining best advertisement frequencies on different platforms that generate best performance measurements.

13. The method of claim 10, further comprising:
obtaining the tree-based model using the historical advertisement data by fitting the tree-based model with a dependent variable related to the user treatment data and an independent variable related to the user feature data; and
updating the tree-based model periodically using new observational data.

14. The method of claim 10, wherein the user feature data comprise: user demographic data, user interest data, online user activity data, and TV view user activity data.

15. The method of claim 9, further comprising:
constructing a plurality of bootstrap samples according to an empirical distribution of the historical data;
computing a plurality of bootstrapped treatment effect estimators respectively based on the plurality of bootstrap samples; and
obtaining a final estimator using the plurality of bootstrapped treatment effect estimators.

16. The method of claim 9, further comprising:
calculating the final treatment effect for the tree-based model at least partially using equation:
$$E = {\sum }_{s} \frac{{N}_{s}}{N} \{ {R}_{s} ( t ) - {R}_{s} ( {t}_{0} ) \} ,$$
wherein E is the final treatment effect, s indicates a leaf node of the tree, t indicates a treatment, Rₛ(t) indicates a treatment effect for the treatment t in the leaf node s, and Rₛ(t₀) indicates a baseline treatment effect in the leaf node s.

17. A non-transitory storage medium configured to store modules comprising:
module for obtaining a tree-based model using advertisement data, the tree-based model comprising a plurality of leaf nodes;
module for obtaining, within at least one leaf node of the tree-based model, a number of subjects and estimating a treatment effect for a treatment;
module for calculating a final treatment effect for the tree-based model using the number of subjects and the treatment effect; and
module for determining a parameter for future advertising strategy using the final treatment effect,
wherein the advertisement data comprise: user treatment data, user feature data, and observational data collected from a plurality of platforms including: Internet platforms and TV networks.

18. The non-transitory storage medium of claim 17,
wherein the user treatment data comprise at least one of: advertisement frequencies, advertisement features, advertisement time slots, advertisement delivery channels; and
wherein the observational data comprises performance measurements of corresponding treatments.

19. The non-transitory storage medium of claim 17, wherein the modules further comprise:
module for constructing a plurality of bootstrap samples according to an empirical distribution of the advertisement data;
module for computing a plurality of bootstrapped treatment effect estimators respectively based on the plurality of bootstrap samples; and
module for obtaining a final estimator using the plurality of bootstrapped treatment effect estimators,
wherein the user feature data comprise: user demographic data, user interest data, online user activity data, and TV view user activity data.

20. The non-transitory storage medium of claim 17, wherein the modules further comprise: module for calculating the final treatment effect for the tree-based model at least partially using equation:
$$E = {\sum }_{s} \frac{{N}_{s}}{N} \{ {R}_{s} ( t ) - {R}_{s} ( {t}_{0} ) \} ,$$
wherein E is the final treatment effect, s indicates a leaf node of the tree, t indicates a treatment, Rₛ(t) indicates a treatment effect for the treatment t in the leaf node s, and Rₛ(t₀) indicates a baseline treatment effect in the leaf node s.
